(19) United States
(12) Patent Application Publication
(10) Pub. No.: US 2002/0089971 A1
(43) Pub. Date: Jul. 11, 2002

(54) Intelligent public communication system

(75) Inventor: Wen-Chao Shih, Chatsworth, CA (US)

Correspondence Address: CHARLES C.H. WU, ESQ., CHARLES C.H. WU & ASSOCIATES, APC, 7700 IRVINE CENTER DRIVE, SUITE 710, IRVINE, CA, 92618-3043, US

(73) Assignee: ADXLINK, INC.

(21) Appl. No.: 09/756,900

(22) Filed: Jan. 9, 2001

(51) Int. Cl. H04L 12/66

(52) U.S. Cl. 370/352; 370/401

(57) ABSTRACT

To practice the invention, an IPCS company such as ADXLINK replaces traditional payphones with Public Web Payphones. Each Public Web Payphone becomes an IPCS gateway using the traditional POTS phone line or a cable line to allow a high speed Internet connection. The Public Web Payphones work like traditional payphones and have the same footprint, which minimizes disruption to the public place. Each Public Web Payphone holds a computer, preferably an industry standard personal computer (PC) to allow easy component upgrade and repair. The PC platform can support various wireless Internet devices as well as an LCD touch screen. The PC allows a user access to Internet services such as e-mail, instant messaging service, and mobile commerce (m-commerce) applications. The Public Web Payphones are connected to a network of other Public Web Payphones and associated media advertising systems to create an Electronic Media Advertising System.

### BACKGROUND OF THE INVENTION

1. Field of the Invention

The present invention relates to methods for delivering internet and advertising to the public.

2. Description of Related Art

Although Internet users can access the Internet easily from the comfort of their own homes, it is often difficult to access the Internet while traveling in public places. Most of today's high foot traffic public locations do not have computers installed to allow easy access to an Internet connection. Local area networks are also absent in many of today's public locations.

The public has a need to read and send e-mails, access the Internet, and obtain digital content with a broad bandwidth and a comfortable human-machine interface. Traditional communications means in public places have been limited to pay phone locations and personal wireless devices. The public needs a worldwide High Speed Wireless Internet Infrastructure.

The public has become increasingly dependent on email services; remote access to corporate intranets and other Internet-based services making wireless Internet access preferable to stationary Internet access. Because travelers in public places are very mobile, they are often inconvenienced by having to stop near a public pay phone.

Two studies from The Strategis Group well support the blossoming future of wireless Internet access. Global service revenues from the fixed wireless broadband are projected to reach $US 16.3 billion by 2004, a compound annual growth rate of 140 percent over 1999 revenues. Source: The Strategis Group, May 2000.

Another statistical report of NTT, the Japanese wireless telecommunication giant, shows explosive growth in the subscriber numbers for its wireless Internet service i-Mode. The wireless Internet demanded by mobile users is the same Internet the get in their offices and homes. The ideal wireless Internet service for mobile users must be broadband, always on, unlimited usage, and as affordable as fixed location Internet service.

The Internet and wireless industry offers several solutions to this long felt need. Mobile phone companies provide Internet access to mobile phones. Mobile phones have many disadvantages. The screen is small and not able to show much information. The keys are small making it hard to enter data. The bandwidth is not expected to improve substantially until the introduction of 3G technologies in 2002. Several wireless services available for handheld device owners, such as Omnisky are restricted to limited areas with narrow bandwidth allowing text-mode operations only. Furthermore, the wireless service is limited to specific handheld devices.

Also, the long-range radio frequency connection in mobile phones makes them unreliable and presents many limitations. Services require new mobile phones with WAP capability. Often, only text format content is available due to lack of bandwidth and display area. Data input demands extraordinary patience and superb finger agility. Future growth in bandwidth is limited to radio frequency availability. Regular computers and handheld devices will need expensive add-on devices to be compatible with mobile wireless services. Airtime connection can be expensive and finally, there is no universal worldwide standard.

A physically installed and wired location can provide the necessary bandwidth that mobile users demand. Some services allow network connections by installing network transmitters in public places. One example is MobileStar, which uses the IEEE 802.11b standard with FH & DS. They provide hardware with a service package. Wireless broadband access is sold to business travelers who install hardware on their mobile devices or PC's. Network nodes are deployed around the country to provide the service to users. Unfortunately, the service is limited to certain users that have the hardware package properly installed. The service areas are limited and network node deployment requires additional installation space in new areas. Many places lack a suitable node installment area making the network unreliable.

Business Centers can provide business travelers with wireless and high speed Internet access. In certain locations, business travelers can visit the AERZONE Business Center, which features a T-1 connection and a Wireless LAN IEEE 802.11b. The AERZONE Business Center provides business travelers with Internet access. The major drawbacks to the business center approach are that it requires a large space to setup the business center and wireless services are provided to customers only.

Console Booths are another alternative to deliver advertising and Public Internet Access to travelers. The Get2Net Company features a T-1 Fixed Connection at console booths that provide free public Internet access. Unfortunately, Console Booths require large footprint space to setup. A Console Booth only serves one users per booth and does not allow a users' wireless device to have high speed access to the Internet.

A notable feature of the console booth is that it has the potential to allow advertisers to reach users in a public place through display advertising and also allow advertisers to reach online customers at the same time. Online advertising revenues surged in 1999 and are estimated at $4.62 billion. 2000 first-quarter revenues rose $1.3 billion or 182% over 1999 first quarter, according to the report of Internet Advertising Bureau's Internet Advertising Report Q1 2000. The market of net advertising is expected to reach $24.4 billion by 2004, according to a study conducted by investment banking firm Veronis Suhler.

Thus, an installed location allows high speed Internet access and also allows advertisers to reach users. In the past Kiosks advertised by electronic means. A kiosk is a small physical structure (often including a computer and a display screen) that displays information for people walking by. Kiosks are common near the entrances of shopping malls in North America where they provide shoppers with directions. Kiosks are also used at trade shows and professional conferences where they loop content displays and can advertise. The main drawback to a Kiosk is that it does not engage the user and is largely ignored. Kiosks are also not networked making ad management and system maintenance more difficult.

### SUMMARY OF THE INVENTION

To practice the invention, an IPCS company such as ADXLINK replaces traditional payphones with Public Web Payphones. Each Public Web Payphone becomes an IPCS gateway using the traditional POTS phone line or a cable line to allow a high speed Internet connection. The Public Web Payphones work like traditional payphones and have the same footprint, which minimizes disruption to the public place. Each Public Web Payphone holds a computer, preferably an industry standard personal computer (PC) to allow easy component upgrade and repair. The PC platform can support various wireless Internet devices as well as an LCD touch screen. The PC allows a user access to Internet services such as e-mail, instant messaging service, and mobile commerce (m-commerce) applications. The Public Web Payphones are connected to a network of other Public Web Payphones and associated media advertising systems to create an Electronic Media Advertising System.

### BRIEF DESCRIPTION OF THE DRAWINGS

FIG. 1 is a diagram of the IPCS system.

### DESCRIPTION OF THE PREFERRED EMBODIMENT

To practice the invention, an IPCS company such as ADXLINK replaces traditional payphones with Public Web Payphones. Each Public Web Payphone becomes an IPCS gateway using the traditional POTS phone line or a cable line to allow a high speed Internet connection. The Public Web Payphones work like traditional payphones and have the same footprint, which minimizes disruption to the public place.

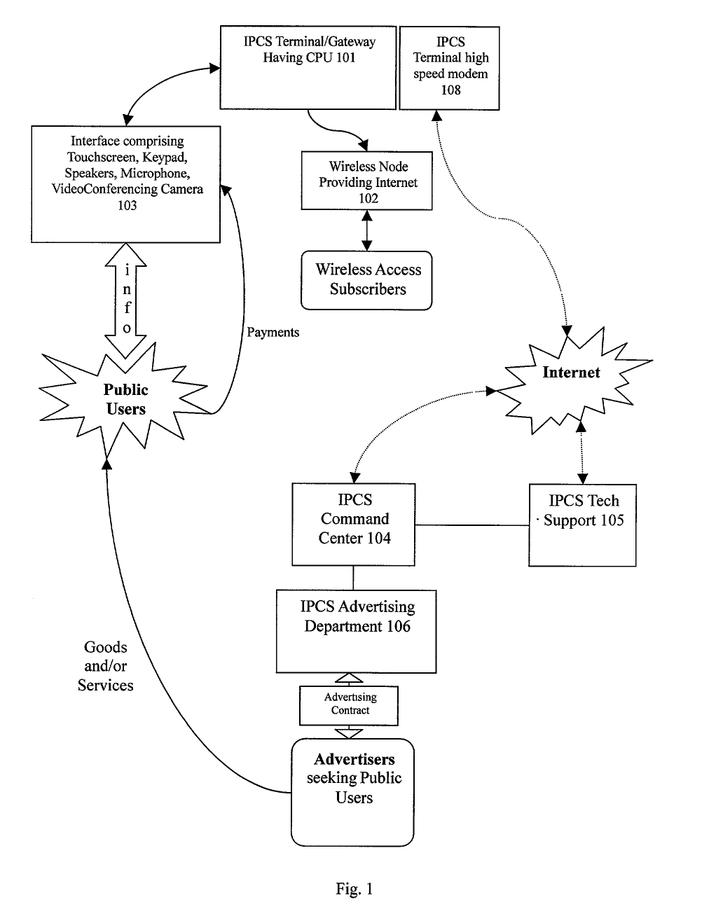

Each Public Web Payphone FIG. 1, holds a computer, preferably an industry standard personal computer (PC) 101 to allow easy component upgrade and repair. The PC platform can support various wireless Internet devices as well as an LCD touch screen 103. The PC allows a user access to Internet services such as e-mail, instant messaging service, and mobile commerce (m-commerce) applications. The Public Web Payphones are connected to a network of other Public Web Payphones and associated media advertising systems to create an Electronic Media Advertising System.

The preferred embodiment of the Public Web Payphone is a web-based payphone having a 15 inch LCD touch screen 103. A broadband Internet connection device will make it capable of maintaining a PSTN phone connection 108. The latest and most broadly accepted wireless networking technologies IEEE 802.11b and Bluetooth™ will be added to the IPCS gateway to create WLAN/WPAN public environments and provide highly reliable, broadband, and extremely affordable Internet access for mobile users.

The LCD screen 103 allows interactive broadcasting in high traffic locations. When wireless users want a high-speed connection they look to see if a Public Web Payphone is nearby. The LCD screen flashes advertising. Pedestrian traffic, bored people waiting in lounge areas, and payphone users all become passive recipients of advertising. Advertising on the Public Web Payphone can present an upscale technology image that Internet companies and fortune 500 companies want and need.

Public Web Payphone provides Infotainment. Three-minute video loops deliver the daily news, weather, sports highlights, interactive games, and trivia. Content can include Advertisements and Public Messages.

The PC allows a broadband connection, which in turn allows a public Internet infrastructure, providing wireless access, public event announcements, immediate broadcasting, mobile commerce applications, multimedia online advertising, public payphone service on voice-over-IP, Internet access, wireless Internet access (Bluetooth public wireless access), local information, video-conferencing, and Electronic money transfer.

Another attractive factor for people to use these public web payphones is to provide certain amount of free-to-use strategy. The users can use these to call anywhere worldwide as well as surf on the Internet free of charge for the beginning minute.

Intelligent Public Communication Station (IPCS, or Web Payphone) is a fully integrated, well developed, Internet enable appliance. ADXLINK develops and markets the IPCS just on the main stream of Internet age. IPCS features various functions—advertising, payphone communication, online transactions, m-commerce approaching, and information providing, etc. It has every service you will need when you are on the road.

IPCS has special coated alloy external housing that is stylish and durable in severe environments. Its 12.1″/15″ active matrix LCD touch screen connects people to the Internet, and allows a platform for online advertising. The lightweight, integrated design of the IPCS gateway booth should harmoniously match existing interior designs.

Each IPCS gateway installation will likely require individual negotiation depending upon its pedestrian traffic, and characteristics. The IPCS gateway company can contract on a long-term basis with the owner of each site by partnering with the, or lasing the space. In most cases, IPCS gateway company pays 100% of costs of purchasing and installation of each IPCS gateway.

The two steps to installation and business development begin with Online Advertising (or Internet advertising), followed by Wireless Internet Infrastructure. Providing public payphone service, public Internet access services, and online advertising services is the first step to establishing the IPCS gateway network. Once the gateway network grows to an acceptable service area the IPCS gateway network can start selling wireless service packages with various combinations of hardware, software and monthly rates. The IPCS gateway network company can also cooperate with major laptop computer manufacturers to integrate the ADXLINK wireless service with their products as an add-on option for new laptop buyers.

Online advertising can be sold to national and local advertisers through the IPCS advertising department 106. Advertising agreements can be signed for a term of between one month and three years. The advertising agreements can provide the advertising client with interactive multimedia commercials on 50 to 500 IPCS gateways. The advertisements play at set intervals, daily, with frequency that is determined in the negotiation of the agreement. The IPCS gateway network staff can design full color, 2D/3D, and animated commercials or digitize film and live video provided by clients. The commercials can be remotely transferred to the IPCS via a broadband network.

The various services provided by the IPCS gateway are designed to draw a customer to the LCD screen. A customer seeing an advertisement on the screen can interact with the advertisement by visiting the advertising company's website or ask for more information. The advertisement can offer the customer special deals on products and the customer can order the products online. Ordering is made simple by installing a credit card, back card, charge card or multi-card reader with the IPCS gateway. If the customer needs to speak to customer service, the web phone can automatically dial the advertising company's customer service. By allowing a customer to instantly purchase products, advertisements become more effective.

How does IPCS Work?

Three components make up the complete IPCS network. First is the IPCS network terminal, which combines traditional payphone capabilities with sponsor-paid advertising and content, m-commerce and personalized information services from the Internet. However, IPCS is not an Internet kiosk.

The second component is the I-Center, a comprehensive system for “back office” support, content management and delivery. The I-Center performs the technical management of content, implements delivery of content, and services the IPCS terminal network.

The third component of the IPCS network is the content management service center. These service center reports on usage, effectiveness and measurement tools for sponsor-paid content. The I-Center and Content Management Service Center are shown as the IPCS Command Center 104.

Advertising Engine

The advertising engine allows the IPCS Command Center 104 and IPCS Advertising Department 106 to remotely control IPCS Terminals.

Sponsor Registration and Management: IPC S'advertising engine integrates Customer Account Management, Advertisement Submission, and Advertisement Preview and Confirmation. These functions will be able to be performed online with secured transmission. The database maintained through these interfaces will be readily integrated into the corporate customer resources management system.

File Management: The file management on IPCS terminals can be performed remotely via web-interface systems. Commons tasks performed on IPCS file system are refreshing, synchronization and backup.

Advertisement Upload/Download: The advertisement files are updated/deleted via FTP protocol with file transmission integrity verifications, which guarantee the system stability and the advertisement quality.

Script Scheduling/Control: The advertisement display is controlled by server/client script mechanism. The advertisement or message display on IPCS network is scheduled, with tolerance to perform insertion. The network display will be monitored with server/client applications.

Statistic Report: Comparing to traditional media, such as television/radio broadcast, and newspapers, online advertising features highly accurate and detailed records regarding advertisement delivery. The statistics of advertisement delivery include requests, traffic, impressions, click-through rates, bandwidth utilization rate and customer psychographics information. The data provides extremely valuable references for sponsors' sales and marketing personnel, as well as IPCS network operations.

Electronic Payment System: IPCS' advertising engine features Secured Transaction Mechanism to form a solid sector of mobile commerce.

Wireless Internet Services Engine Networked Bandwidth Control: In the topology of IPCS wireless network, each single IPCS wireless gateway is able to serve multiple users simultaneously. The gateway is similar to what the industry calls a wireless network node 102. The network node 102 can be installed in the IPCS wireless gateway, which is connected to a high-speed Internet service 108.

The wireless service engine is able to control the data flow rate and distribute bandwidth among users. In addition, the IPCS wireless network usually has more than one IPCS gateway in one location. The wireless network engine is able to reassign users among a cluster of gateways to optimize the users' wireless connection.

Network Access and Usage Log: The wireless network engine records the data transmission rate, data amount, and all other necessary network accessing information log. The recorded statistics will be used as the reference for network development/modification, location revenue distribution, and media development.

Security: The wireless network access has fast frequency hopping feature (79 channels for Bluetooth/IEEE 802.11b FHSS) and thus is virtually impossible to trace. The wireless engine requires authentication of remote device based on 128-bit link key, and may be performed in both directions. The data transmission has encryption using stream cipher algorithm (≦128-bit) and the encryption affects all traffic on a single link. The connection initialization may require a PIN entry by user.

Interactive Push: The wireless engine is able to identify devices entering the network and send out information according to the users' profiles. For example, the engine will issue out an electronic coupon of a nearby store, or the local weather information to the specific user walking into the range of the network.

Wireless Solutions: The following technologies are currently available or under development in the wireless industry: Satellite, Cellular Phone, PCS Phone, Wireless Modem, IEEE 802.11 Wireless LAN, HomeRF, Bluetooth, IrDA 1.1 and Apple/Lucent Airport.

IPCS should adopt Bluetooth™ as its main wireless network architecture. Bluetooth™ is the best low-cost radio link technology, and perfect for mobile devices due to its small, low power, low cost and high performance characteristics. Bluetooth™ is an open, royalty free specification, and currently has 1,900 more SIG members, including Compaq, Dell, Sony, Toshiba, IBM, Nokia, Ericsson, Intel, and Microsoft.

The Bluetooth™ wireless technology allows users to make effortless, wireless and instant connections between various communication devices, such as handheld devices, laptop and desktop computers. Since it uses radio transmission, transfer of both voice and data is in real-time. The sophisticated mode of transmission adopted in the Bluetooth specification ensures protection from interference and security of data.

The Bluetooth™ radio is built into a small microchip and operates in a globally available frequency band ensuring communication compatibility worldwide. The Bluetooth™ specification has two power levels defined; a lower power level that covers the shorter personal area within a room, and a higher power level that can cover a medium range, such as within a home. Software controls and identity coding built into each microchip ensure that only those units preset by their owners can communicate.

The Bluetooth™ wireless technology supports both point-to-point and point-to-multipoint connections. With the current specification, up to seven “slave” devices can be set to communicate with a “master” radio in one device. Before year 2002, the Bluetooth™ technology will be built into hundreds of millions of electronic devices. The IPCS network will then be ready to provide a well-established network infrastructure for Bluetooth™ wireless Internet.

In additional to Bluetooth™, IEEE 802.11b WLAN is a technology available today and has higher bandwidth. IPCS will initiate its wireless Internet services via WLAN technology, and expand the services to Bluetooth™ area once the market is ready.

1. A method of establishing and maintaining an IPCS system comprising the steps of:
a. replacing traditional public phone installation locations with IPCS Internet gateways, said IPCS Internet gateways having a CPU and a touch screen;
b. connecting IPCS Internet gateways to the Internet through broadband Internet connections;
c. providing access to the Internet through the IPCS Internet gateways whereby a user can navigate the Internet using the touch screen; and
d. providing access to traditional public payphone service using voice-over-IP,
whereby a user's voice connection is sent digitally over broadband Internet connections.

2. The invention of claim 1, further comprising the step of: (e) providing news and media content to users, and (f) managing said news and media content from a remote location through the Internet comprising the steps of:
a. selecting news and media content; and
b. displaying news and media content.

3. The invention of claim 1, further comprising the step of (f): providing wireless Internet access through the IPCS Internet gateway.

4. The invention of claim 1, further comprising the step of (g): providing video-conferencing through the IPCS Internet gateway.

5. The invention of claim 1, further comprising the step of (h): providing electronic money transfer services through the IPCS Internet gateway.

6. The invention of claim 1, further comprising the step of: (i) displaying online multimedia advertising and (j) managing said advertising from a remote location through the Internet comprising the steps of:
a. selecting advertising content; and
b. displaying advertising content.

7. The invention of claim 6, further comprising the step of: (i) installing a multi-card reader to allow a user to purchase in response to online multimedia advertising.

8. The invention of claim 7, further comprising the step of: (e) providing news, media and information services to users.

9. The invention of claim 7, further comprising the step of (f): providing wireless Internet access through the IPCS Internet gateway.

10. The invention of claim 7, further comprising the step of (g): providing video-conferencing through the IPCS Internet gateway.

11. The invention of claim 7, further comprising the step of (h): providing electronic money transfer services through the IPCS Internet gateway.

12. The invention of claim 7, further comprising the step of: (i) displaying online multimedia advertising.

13. A method of establishing and maintaining an IPCS system comprising the steps of:
a. an IPCS Internet gateway having a CPU and a touch screen;
b. connecting IPCS Internet gateways to the Internet through broadband Internet connections;
c. providing access to the Internet through the IPCS Internet gateways whereby a user can navigate the Internet using the touch screen; and
d. providing access to traditional public payphone service using voice-over-IP,
whereby a user's voice connection is sent digitally over broadband Internet connections.

14. The invention of claim 13, further comprising the step of: (e) providing news and media content to users, and (f) managing said news and media content from a remote location through the Internet comprising the steps of:
a. selecting news and media content; and
b. displaying news and media content.

15. The invention of claim 13, further comprising the step of (f): providing wireless Internet access through the IPCS Internet gateway.

16. The invention of claim 13, further comprising the step of (g): providing video-conferencing through the IPCS Internet gateway.

17. The invention of claim 13, further comprising the step of (h): providing electronic money transfer services through the IPCS Internet gateway.

18. The invention of claim 13, further comprising the step of: (i) displaying online multimedia advertising and (j) managing said advertising from a remote location through the Internet comprising the steps of:
a. selecting advertising content; and
b. displaying advertising content.

19. The invention of claim 18, further comprising the step of: (i) installing a multi-card reader to allow a user to purchase in response to online multimedia advertising.

20. The invention of claim 19, further comprising the step of: (e) providing news, media and information services to users.

21. The invention of claim 19, further comprising the step of (f): providing wireless Internet access through the IPCS Internet gateway.

22. The invention of claim 19, further comprising the step of (g): providing video-conferencing through the IPCS Internet gateway.

23. The invention of claim 19, further comprising the step of (h): providing electronic money transfer services through the IPCS Internet gateway.

24. The invention of claim 19, further comprising the step of: (i) displaying online multimedia advertising.
